(19) United States
(12) Patent Application Publication
(10) Pub. No.: US 2012/0151942 A1
(43) Pub. Date: Jun. 21, 2012

(54) COMPACT, HIGH EFFICIENCY VESSEL BLANKETING SYSTEM

(76) Inventors: George James Zamiar, Louisville, KY (US); Kyle William White, LaGrange, KY (US)

(21) Appl. No.: 13/325,374

(22) Filed: Dec. 14, 2011

Related U.S. Application Data
(60) Provisional application No. 61/423,165, filed on Dec. 15, 2010.

(51) Int. Cl. F17C 13/02

(52) U.S. Cl. 62/49.1

(57) ABSTRACT

A volatile liquid vapor vessel blanketing apparatus includes at least one volatile liquid storage tank with volatile vapors to be recovered, a pressure regulator that maintains a set blanketing pressure of natural gas on the storage tank and a regulator inhibitor. The apparatus further includes a check valve, a vapor recovery compressor and a conduit system. The conduit system connects the pressure regulator, regulator inhibitor, check valve and vapor recovery compressor to a storage tank vapor outlet of the at least one storage tank and a natural gas supply. The regulator inhibitor automatically inhibits operation of the pressure regulator when the vapor recovery compressor is pumping vapor from the storage tank.

This application claims the benefit of U.S. Provisional Patent Application Ser. No. 61/423,165, filed on 15 Dec. 2010, the full disclosure of which is incorporated herein by reference.

### TECHNICAL FIELD

The present invention relates generally to the field of volatile liquid vapor recovery and, more particularly, to an apparatus of relatively simple and compact design and a related method both furnishing high efficiency operation and reduced operating costs.

### BACKGROUND

When handling and/or extracting natural gas, waters and oils are separated from the main stream and stored in batteries of pressure vessels. In the past, when it was necessary to drain these vessels, ambient air was allowed to enter the vessels in order to avoid vacuum conditions. Unfortunately, this creates a mixture of hydrocarbon volatiles and air including reactive oxygen inside the vessels.

At other times, the delivery of additional water and oils raises the pressure inside the vessels to a point that pressure relief is required. At those times it is necessary to vent the vessels to atmosphere. However, the venting of volatile liquid vapors directly to atmosphere is not acceptable. The resulting combustion products are not an ideal environmental solution. Accordingly, gas wells have typically been equipped with gas flares or flare stacks to burn the volatiles. Alternatively, volatile liquid vapor scrubbing systems may be used. Examples of such systems are disclosed in, for example, U.S. Pat. No. 5,515,686 to Jordan, U.S. Pat. No. 5,591,254 to Gibson, U.S. Pat. No. 5,871,568 to Gibson and U.S. Pat. No. 5,853,455 to Gibson, all owned by the Assignee of the present invention.

Such systems generally include (a) a pair of reaction vessels with each vessel including a bed of adsorbent for adsorbing volatile liquid vapor and producing relatively volatile liquid vapor free air, (b) a vacuum pump for regenerating the adsorbent bed in each of the reaction vessels and releasing previously absorbed volatile liquid vapor and (c) an absorber tower to enhance vapor recovery. Such devices are relatively large and require complicated piping making them a capital intensive solution that is generally unsuitable for small volatile liquid vapor dispensing facilities such as gasoline stations, convenience stores, small gasoline truck loading terminals and gas wells. Further, they are also not generally suitable for ground remediation equipment due to a lack of portability. The present invention addresses this problem by providing a simplified and more compact vapor recovery apparatus that does not include an absorber tower but still operates with high efficiency. Such an apparatus is less capital intensive and better suited for use on gas wells and the like.

### SUMMARY

In accordance with the purposes and advantages as described herein a novel volatile liquid vapor vessel blanketing apparatus is provided. The blanketing apparatus includes at least one volatile liquid storage tank with volatile vapors to be recovered, a pressure regulator that maintains a set blanketing pressure of natural gas on the at least one storage tank and a regulator inhibitor. In addition, the apparatus includes a check valve, a vapor recovery compressor and a conduit system. The conduit system connects the pressure regulator, the regulator inhibitor, the check valve and the vapor recovery compressor to a storage tank vapor outlet on the storage tank and a natural gas supply. The regulator inhibitor automatically inhibits operation of the pressure regulator when the vapor recovery compressor is pumping vapor from the at least one storage tank to a natural gas sales line.

The regulator inhibitor may be selected from a group of devices consisting of a shuttle valve, at least one electronic solenoid, a pneumatic isolation element and a shut off valve. In one particularly useful embodiment the regulator inhibitor is a shuttle valve. The check valve feeds pressure to the shuttle valve which controls the operation of the pressure regulator.

Still further, the conduit system includes a compressor discharge line downstream from the compressor and a compressor intake line between the at least one storage tank and the compressor. The shuttle valve is connected between the compressor discharge line and the compressor intake line by a first signal line. The pressure regulator is connected between the compressor discharge line and the compressor intake line by a second signal line. Further, the check valve is provided in the compressor discharge line between the first and second signal lines.

In one useful embodiment the apparatus is all mechanical with no electronic controls between the shuttle valve, the pressure regulator and the check valve.

In accordance with an additional aspect, a method is provided for blanketing a liquid in a storage tank with a gas blanket at a desired pressure. The method comprises the steps of maintaining a desired blanket pressure in a volatile liquid vapor storage tank by operation of a pressure regulator and connecting the pressure regulator between the storage tank and a source of natural gas supply. The method further includes the steps of adding blanketing natural gas to the storage tank by the pressure regulator when the blanket pressure in the storage tank falls below the desired blanket pressure and interrupting operation of the pressure regulator and preventing additional blanketing gas from being delivered to the storage tank when vapors in the storage tank are being pumped from the storage tank with a volatile liquid vapor compressor. In addition, the method further includes the step of preventing air from entering the storage tank and eliminating any venting of the storage tank to atmosphere during normal operation.

In the following description there is shown and described a volatile liquid vapor vessel blanketing apparatus and method of blanketing. The drawings and descriptions should be regarded as illustrative in nature and not as restrictive.

### BRIEF DESCRIPTION OF THE DRAWINGS

The accompanying drawings incorporated herein and forming a part of the specification, illustrate several aspects of the volatile liquid vapor vessel blanketing apparatus and together with the description serve to explain certain principles of the apparatus. In the drawings:

FIG. 1 is a schematical representation of the volatile liquid vapor vessel blanketing apparatus.

Reference will now be made in detail to the present preferred embodiments of the apparatus, examples of which are illustrated in the accompanying drawing.

### DETAILED DESCRIPTION

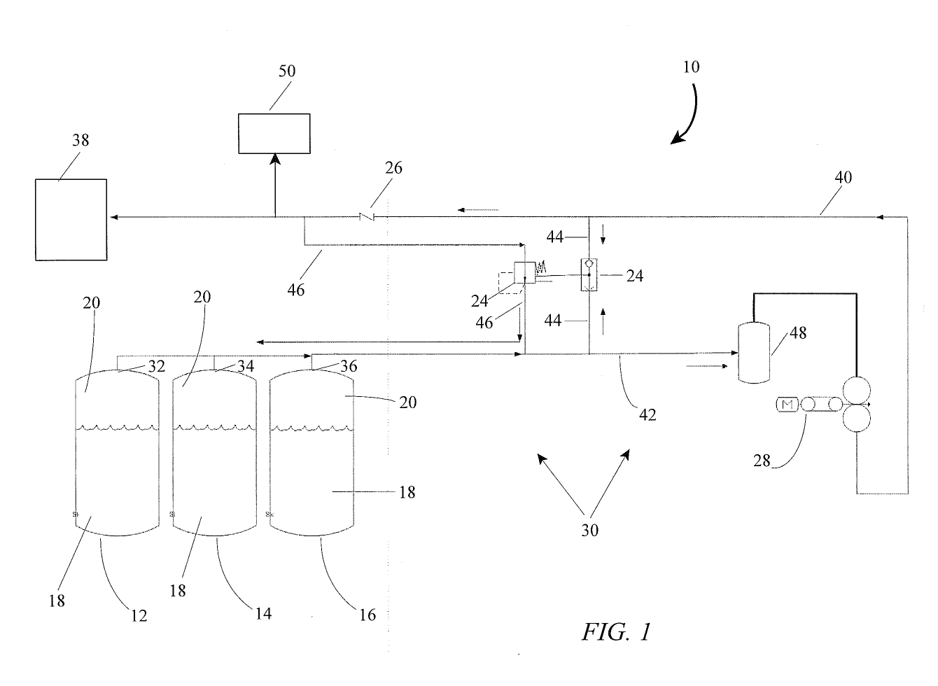

As illustrated in FIG. 1, the volatile liquid vapor vessel blanketing apparatus 10 comprises three volatile liquid storage tanks 12, 14, 16. Each tank 12, 14, 16 holds a volatile liquid 18. A vapor 20 fills the space between the upper surface of the volatile liquid 18 and the top of the tanks 12, 14, 16. While three tanks 12, 14, 16 are illustrated in the drawing figure, it should be appreciated that the apparatus may include substantially any number of tanks from 1 to n.

The apparatus 10 also includes a pressure regulator 22 that functions to maintain a set blanketing pressure of vapor or natural gas 20 over the liquid 18 in the storage tanks 12, 14, 16. Further, the apparatus 10 includes a regulator inhibitor 24, a check valve 26 and a vapor recovery compressor 28. A conduit system, generally designated by reference numeral 30, connects the pressure regulator 22, the regulator inhibitor 24, the check valve 26 and the vapor recovery compressor 28 to the storage tank vapor outlets 32, 34, 36 of the respective storage tanks 12, 14, 16, respectively and to a natural gas supply 38. More specifically, the conduit system 30 includes a compressor discharge line 40 downstream from the compressor 28 and a compressor intake line 42 between the storage tanks 12, 14, 16 and the compressor 28.

The regulator inhibitor 24 may take any number of forms including such devices as a shuttle valve, at least one electronic solenoid, a pneumatic isolation element and a shutoff valve. In one particularly useful embodiment the regulator inhibitor 24 is a shuttle valve.

The regulator inhibitor/shuttle valve 24 is connected between the compressor discharge line 40 and the compressor intake line 42 by a first signal line 44. Similarly, the pressure regulator 22 is connected between the compressor discharge line 40 and the compressor intake line 42 by a second signal line 46. As further illustrated, the check valve 26 is provided in the compressor discharge line 40 between the first and second signal lines 44, 46. An optional liquid knock out tank 48 may be provided in the compressor intake line 42 between the storage tanks 12, 14, 16 and the compressor 28. This liquid knock out tank 48 traps any liquid drawn from the storage tanks 12, 14, 16 or condensing in the line 42 so that it does not reach the vapor recovery compressor 28.

In the illustrated embodiment the check valve 26 feeds pressure to the regulator inhibitor/shuttle valve 24 controlling operation of the pressure regulator 22. In this way the regulator inhibitor/shuttle valve 24 automatically inhibits operation of the pressure regulator 22 when the vapor recovery compressor 28 is pumping vapor from one or more of the storage tanks 12, 14, 16 through the compressor intake line 42, the compressor 28 and the compressor discharge line 40 to, for example, a natural gas sales line 50. It should be appreciated that the illustrated embodiment of the apparatus 10 is all mechanical with no electronic controls between the regulator inhibitor/shuttle valve 24, the pressure regulator 22 and the check valve 26.

In accordance with the purposes of the present invention as described herein, the apparatus 10 is provided for maintaining the storage tanks 12, 14, 16 at an appropriate pressure range without using outside air or other foreign gases such as relatively expensive inert gasses like nitrogen. Such an apparatus 10 uses well gas to maintain the pressure in the tanks above admissible limits. In this way it is possible to advantageously minimize reactive oxygen in the storage tanks 12, 14, 16 and conduit system 30 while also effectively eliminating the need to vent the apparatus 10, including the storage tanks, to atmosphere.

Toward this end, the pressure regulator 22 maintains a set blanket or vapor pressure o the storage tanks 12, 14, 16. The check valve 26 feeds pressure to the regulator inhibitor/shuttle valve 24 controlling the signal to the regulator 22; and the shuttle valve controls the signal pressure to the regulator. The apparatus 10 is characterized by the use of a shuttle valve 24 to inhibit the regulator action when the vapor pressure in the tanks 12, 14, 16 is being bled by a compressor 28.

More particularly, the pressure regulator 22 maintains a certain blanket pressure on the storage tanks 12, 14, 16. When the tank pressure drops, the regulator 22 allows flow of well gas from the natural gas supply 38 to increase it back up to the desired level. If the evacuating compressor(s) 28 is/are working via the check valve 26 a pressure signal from the discharge of the compressor is sent to the shuttle valve 24 to inhibit the action of the regulator 22.

As should be appreciated the apparatus 10 operates in accordance with a unique and novel method for blanketing a volatile liquid 18 in a storage tank 12, 14 and/or 16 with a vapor or gas blanket 20 at a desired pressure. The method may be broadly described as comprising the steps of maintaining a desired blanket pressure in a volatile liquid vapor storage tank 12, 14, 16 by operation of a pressure regulator 22; connecting the pressure regulator 22 between the storage tank 12, 14, 16 and a natural gas supply 38; adding blanketing natural gas to the storage tank 12, 14, 16 by the pressure regulator 22 when blanket pressure in the storage tank falls below a desired blanket pressure; and interrupting operation of the pressure regulator 22 and preventing addition of blanketing natural gas to the storage tank 12, 14, 16 when vapors in the storage tank are being pumped from the storage tank with a volatile liquid vapor compressor 28. The method may be further described as including the steps of preventing air from entering the storage tank 12, 14, 16 and eliminating any venting of the storage tank to atmosphere during normal operation.

In summary, numerous benefits result from employing the concepts disclosed in this document. The volatile liquid vessel blanketing apparatus 10 is particularly useful in increasing the efficiency and lowering the operating costs of a typical volatile liquid vapor installation such as is found at a gas well where the volatile liquid is retrieved from the underground and put through a series of drop out tanks so that liquids and vapors are separated before routing to storage tanks 12, 14, 16. In these storage tanks 12, 14, 16, further separation occurs and vapors are evacuated by the compressor 28. Liquids 18 may be drained from the tanks via draining lines (not shown). Typically the vapors 20 are removed when the pressure increases to a point closest to the vessel maximum design pressure with the aid of the pressure compressor 28. This operation brings the pressure in the tank 12, 14, 16 to a preset working pressure. When the liquids are evacuated, the pressure drops near the minimum allowed working pressure for the tanks 12, 14, 16. Existing designs allow air into the tanks 12, 14, 16 to increase the pressure via a manual valve or a pressure vacuum vent valve. In contrast, the present invention allows well gas vapors to enter into the tanks 12, 14, 16 via the pressure regulator 22. The pressure regulator 22 is actuated via the shuttle valve 24 which permits the pilot pressure signal only to actuate the regulator when vapors are not being evacuated from the tanks 12, 14, 16 via the compressor 28. In the event tank pressure is dropping due to the compressor operation via the check valve 26, a signal forces the shuttle valve 24 to inhibit the operation of the regulator 22 by shifting and stopping the pilot signal from reaching the regulator. Thus, the apparatus 10 functions efficiently and effectively to maintain pressure in the tanks 12, 14, 16 within a desired operating range under substantially any foreseeable operating conditions. Advantageously, the apparatus maintains the proper working pressure within the tanks 12, 14, 16 without allowing entrance of air and more particularly reactive oxygen into the system. Further, when operating properly, the apparatus effectively eliminates the need to ever vent to atmosphere. Thus, the potential for harmful volatile vapor discharge into the ambient air is virtually negated thereby benefiting the environment.

The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims in their fair and broad interpretation in any way.

What is claimed:

1. A volatile liquid vapor vessel blanketing apparatus comprising:
at least one volatile liquid storage tank with volatile vapors to be recovered;
a pressure regulator that maintains a set blanketing pressure of natural gas on said at least one storage tank;
a regulator inhibitor;
a check valve;
a vapor recovery compressor; and
a conduit system connecting said pressure regulator, said regulator inhibitor, said check valve and said vapor recovery compressor to a storage tank vapor and a natural gas supply;
said regulator inhibitor automatically inhibiting operation of said pressure regulator when said vapor recovery compressor is pumping vapor from said at least one storage tank.

2. The apparatus of claim 1, wherein said regulator inhibitor is selected from a group of devices consisting of a shuttle valve, at least one electronic solenoid, a pneumatic isolation element and a shut off valve.

3. The apparatus of claim 1, wherein said regulator inhibitor is a shuttle valve.

4. The apparatus of claim 3, wherein said check valve feeds pressure to said shuttle valve controlling operation of said pressure regulator.

5. The apparatus of claim 4, wherein said conduit system includes a compressor discharge line downstream from said compressor and a compressor intake line between said at least one storage tank and said compressor.

6. The apparatus of claim 5, wherein said shuttle valve is connected between said compressor discharge line and said compressor intake line by a first signal line.

7. The apparatus of claim 6, wherein said pressure regulator is connected between said compressor discharge line and said compressor intake line by a second signal line.

8. The apparatus of claim 7, wherein said check valve is provided in said compressor discharge line between said first and second signal lines.

9. The apparatus of claim 1, including a liquid knock out tank in said compressor intake line between said at least one storage tank and said compressor.

10. The apparatus of claim 1, wherein said apparatus is all mechanical with no electronic controls between said shuttle valve, said pressure regulator and said check valve.

11. A method for blanketing a liquid in a storage tank with a gas blanket at a desired pressure, comprising:
maintaining a desired blanket pressure in a volatile liquid vapor storage tank by operation of a pressure regulator;
connecting said pressure regulator between said storage tank and a natural gas supply;
adding blanketing natural gas to said storage tank by said pressure regulator when blanket pressure in said storage tank falls below said desired blanket pressure; and
interrupting operation of said pressure regulator and preventing addition of blanketing natural gas to said storage tank when vapors in said storage tank are being pumped from said storage tank with a volatile liquid vapor compressor.

12. The method of claim 11, further including preventing air from entering said storage tank.

13. The method of claim 12, including eliminating any venting of said storage tank to atmosphere during normal operation.
